(19) United States
(12) Patent Application Publication
(10) Pub. No.: US 2004/0195063 A1
(43) Pub. Date: Oct. 7, 2004

(54) Fluid coupled vehicle speed retarder

(76) Inventors: John C Simonis, San Antonio, TX (US); James E Johnson, San Antonio, TX (US); Joseph E Crouch, San Antonio, TX (US)

Correspondence Address: COX & SMITH INCORPORATED, 112 EAST PECAN STREET, SUITE 1800, SAN ANTONIO, TX, 78205-1521, US

(21) Appl. No.: 10/472,608

(22) PCT Filed: Mar. 22, 2002
(86) PCT No.: PCT/US02/08710

Related U.S. Application Data
(60) Provisional application No. 60/278,087, filed on Mar. 22, 2001.

(51) Int. Cl. F16F 11/00

(52) U.S. Cl. 188/322.5

(57) ABSTRACT

A fluid coupled speed retarder generating a restraining torque on a vehicule wheel system comprises a restraining shaft (50) coupled by a viscous fluid to a wheel (32) and axle (54) system through a coupling (30) which includes an impeller (48) with radial vanes (77) connected to the restraining shaft and a housing (44) with further radial vanes (46), the housing connected for rotation with the wheel (34). A braking force is developed upon demand by a selective locking of the restraining shaft (50) from motion, the relative motion between the impeller and housing in the viscous coupling generating the barking force.

### BACKGROUND OF THE INVENTION

1. Field of the Invention

The present invention relates generally to devices for coupling one rotating shaft to another rotating shaft. The present invention relates more specifically to a fluid coupled retarding device between a high speed rotating shaft and a lower speed or nonrotating shaft in a manner that may be utilized in conjunction with braking systems on on-road and off-road vehicles.

2. Description of the Related Art

There are currently many different devices and systems whose purpose it is to slow, retard or stop the motion of a vehicle across a surface by directly or indirectly impeding the rotation of the wheels for such a vehicle. These vehicle retarding systems generally fall into four different categories; (1) engine based systems where the engine is operated in a compression mode and linked to the rotating wheels of the vehicle, (2) engine exhaust based systems where manifold pressure is increased, typically through an engine exhaust valve, (3) eddy current coupling based systems where magnetic forces provide a retarding coupling to the metallic components of the rotating wheels or the rotating drive train, and (4) a general class of retarding systems that rely on the use of viscous fluids to provide a retarding coupling. All of these various retarding systems are generally used to provide additional braking forces above and beyond that which is provided by the foundation brakes.

Brake failure, especially for larger tractor trailer vehicles, often occur when excessive braking is experienced on downhill grades. With conventional brake pads, excessive braking will quite rapidly overheat the surfaces of the pads and cause the pads to lose their friction holding capability. It is known that under extreme conditions, conventional brake pads can slip dramatically as superheated layers of gas can form immediately over the surface of the brake pads causing, in some instances, complete failure of the brakes to hold. In such circumstances little or no braking is available to the vehicle operator. Under conditions where the vehicle is running downhill there may be no way to stop the vehicle except through the use of specifically designed and installed road run-offs. It is precisely because of the problems associated with conventional brake failure under high heat conditions that highway systems often install such road run-offs for large tractor-trailer vehicles in downhill terrain.

Some efforts have been made in the past to implement heat removal systems from conventional brake pads so as to reduce the likelihood of the overheating condition described. Other efforts have been made, as mentioned above, to supplement the conventional braking system in such a manner to place less work on the conventional brake pads and diminish the likelihood that they will overheat. Unfortunately, many of the back-up or supplemental systems designed suffer from an overcomplexity that results in their failure more frequently than desired.

It would be desirable to have an auxiliary braking system or vehicle retarder that provided a controlled restraining torque on the wheel system of a vehicle that is in addition to the normal braking system using conventional brake pads. Such a system could be used to retard the motion of a vehicle in the event of a failure of the primary brake system, generally known as the foundation brakes, and additionally would take much of the load off of the primary brake system to prevent its failure in the first place.

Some efforts have been made in the past to utilize fluid couplings for vehicle drive trains that utilize interleaved discs and the like containing highly viscous fluids that couple a variety of rotating shafts. Examples of these efforts are included in U.S. Pat. Nos. 5,363,498, 5,414,260, 5,431,603, and 5,593,012. These referenced patents generally describe concepts that use a highly viscous fluid to strongly couple two rotating systems in a manner that provides slip between the rotating systems only when a predetermined brake away torque is exceeded. These systems therefore act as rotational shock absorbers to allow slippage between the rotating shafts as a means of preventing the overstress and subsequent failure of the drive train components. An example of this can be found when a rotating wheel leaves the ground surface for a period of time, increases its rotational speed and then suddenly comes back into contact with the ground surface creating a shock on the rotating shaft members. A viscous coupling, such as described in the above-referenced patents, can absorb much of the shock by releasing the coupling when excessive torque is experienced.

Contrary to the purpose of the systems described in the above-referenced patents, the present invention addresses the use of a viscous coupling that does not “break away” when a given torque is experienced. Rather, the present concerns are addressed by a system that maintains a fluid coupling between two rotating shafts but exerts a counter rotational force on the higher speed shaft that over time facilitates the reduction in speed of the higher speed rotating shaft. The structures of such a system, as well as the nature of the viscous fluid, are therefore quite distinct from those described above with the referenced patents.

It would be desirable to have an auxiliary braking system for wheeled vehicles that utilizes a viscous fluid to provide fluid shear between rotating components in the drive train of the vehicle in a manner that slows the relative motion between the components. It would be desirable if the system incorporated a fluid that could be used as a medium to extract heat energy generated by the operational braking or retarding of the speed of the vehicle. It would be important for such a system to provide a controlled restraining torque on the wheel system of the vehicle that is in addition to the normal foundation braking system.

### SUMMARY OF THE INVENTION

It is therefore an object of the present invention to provide an auxiliary speed retarding system for a wheeled vehicle that may supplement the braking force provided by the foundation braking system of the vehicle.

It is a further object of the present invention to provide an auxiliary braking system for a wheeled vehicle that not only supplements the foundation braking system but also serves to prevent the foundation braking system from failing.

It is a further object of the present invention to provide a speed retarding system that utilizes a viscous fluid to provide fluid shear between rotating components in the wheel and axle system of a vehicle so as to provide an opposing rotational torque to the higher speed rotating components of the system.

It is a further object of the present invention to provide a viscous fluid coupled speed retarder to slow the relative motion between two rotating components in a vehicle wheel and axle system, and further to provide, by said viscous fluid, a medium for the extraction of heat energy generated by the process of braking or retarding the speed of the vehicle.

In fulfillment of these and other objectives, the present invention provides a fluid coupled vehicle speed retarder that generates a controlled restraining torque on the wheel system of a moving vehicle that is in addition to the normal foundation braking system on the vehicle. The fluid coupled vehicle speed retarder comprises a restraining shaft system coupled by means of a viscous fluid to a wheel and axle shaft system rigidly coupled to one or more of the rotating wheels of the vehicle. Under normal operational conditions the restraining shaft system rotates in conjunction with the wheel and axle shaft system by means of the viscous fluid coupling. In the event of braking, the restraining shaft system is locked to prevent its rotation with respect to the vehicle and with respect to the wheel and axle shaft system. The viscous fluid coupling, which is established within an impeller vane and disc enclosure, serves to create a counter rotational force on the wheel and axle shaft system connected to the wheels of the vehicle. In this manner the viscous fluid and the impeller vane and disc device both retard the speed of the rotating wheels and serve to remove the energy associated with such rotation, and the braking of such rotation, away from the vehicle wheel system. The impeller enclosure comprises a plenum through which a radial array of impeller vanes and impeller discs rotate adjacent to a radial array of impeller ribs that, by counter rotation, serve to force a circulation of the viscous fluid within the impeller enclosure. The impeller enclosure case is connected to the wheel system of the vehicle and rotates at wheel speed. The impeller vane and impeller disc components of the system are rigidly connected to the restraining shaft system and respond to the fixed or rotating condition of the restraining shaft. In this manner a viscous fluid contained within the impeller case serves to couple the two rotating systems so as to cause them to rotate together under normal conditions and to experience the fluid drag caused by the viscous fluid moving through the system when the restraining shaft system is locked under braking conditions.

### BRIEF DESCRIPTION OF THE DRAWINGS

FIG. 1 is a schematic diagram that shows the basic rotating systems of a vehicle utilizing the device and system of the present invention.

FIG. 2 is a partial cross sectional view of one wheel of a vehicle utilizing the system of the present invention.

FIG. 3 is a detailed cross sectional view of the components of the system of the present invention.

FIG. 4 is a detailed side view, in partial cross section, showing the internal components of the system of the present invention.

### DETAILED DESCRIPTION OF THE PREFERRED EMBODIMENT

One goal of the present invention is to provide a speed retarding system that may be readily installed in a retrofit manner on existing wheeled vehicles. The design of the system, therefore, is such that the primary components may be fixed to the external rotating face of one or more wheels of the vehicle. Minor modifications to the balance of the existing axle structure are required to position the restraining system of the present invention and to install a mechanism for locking the restraining shaft upon activation of the foundation brakes. The following description, therefore, involves an embodiment where the primary components of the present invention are positioned on the outside face of the wheels of the vehicle. It is understood, however, that other placements of these components are anticipated, especially where the system might be manufactured as original equipment on a vehicle. The system could, for example, be placed directly between the rotating axle shaft and a fixed position on the vehicle should access to the rotating axle shaft be available. The following description, however, conveys the basic concepts of the present invention and gives one example of an appropriate placement of the system's components.

Reference is made first to FIG. 1 for a brief description of the basic rotating systems of a vehicle utilizing the device of the present invention. FIG. 1 is a schematic diagram that is not intended to show geometric structures so much as the functional relationship between the components of the present invention. Restraining shaft system 10 is shown in FIG. 1 coupled to wheel shaft system 12 by way of viscous coupling fluid 24. Wheel shaft system 12 is comprised of rotating wheel/tire 14 and wheel shaft 16 which are connected by rigid wheel coupling 18 as is well known in the art. Wheel shaft coupling face 20 engages viscous coupling fluid 24 and by such engagement is coupled to restraining shaft coupling face 22.

Restraining shaft system 10 is compromised of rotating restraining shaft 26 that is rigidly attached to restraining shaft coupling face 22. Restraining shaft 26 is operably engaged to locking mechanism 28 as indicated. Locking mechanism 28 may be any of a number of devices known in the art that are operable to lock or stop the rotation of the rotating shaft. Viscous fluid coupling 24 permits locking mechanism 28 to be any of a number of devices which may gradually or quite abruptly stop the rotation of restraining shaft 26.

Under normal operating conditions, restraining shaft system 10 rotates in conjunction with wheel shaft system 12 through viscous coupling fluid 24. When braking is applied to the vehicle, locking mechanism 28 stops the rotation of restraining shaft system 10. Viscous coupling fluid 24 then experiences the rotational shear forces that, because of the structure of the retarding impeller system of the present invention, provides a counter rotational torque to wheel shaft system 12. In this manner, the rotational speed of wheel shaft system 12 is reduced in response to the counter rotational torque produced.

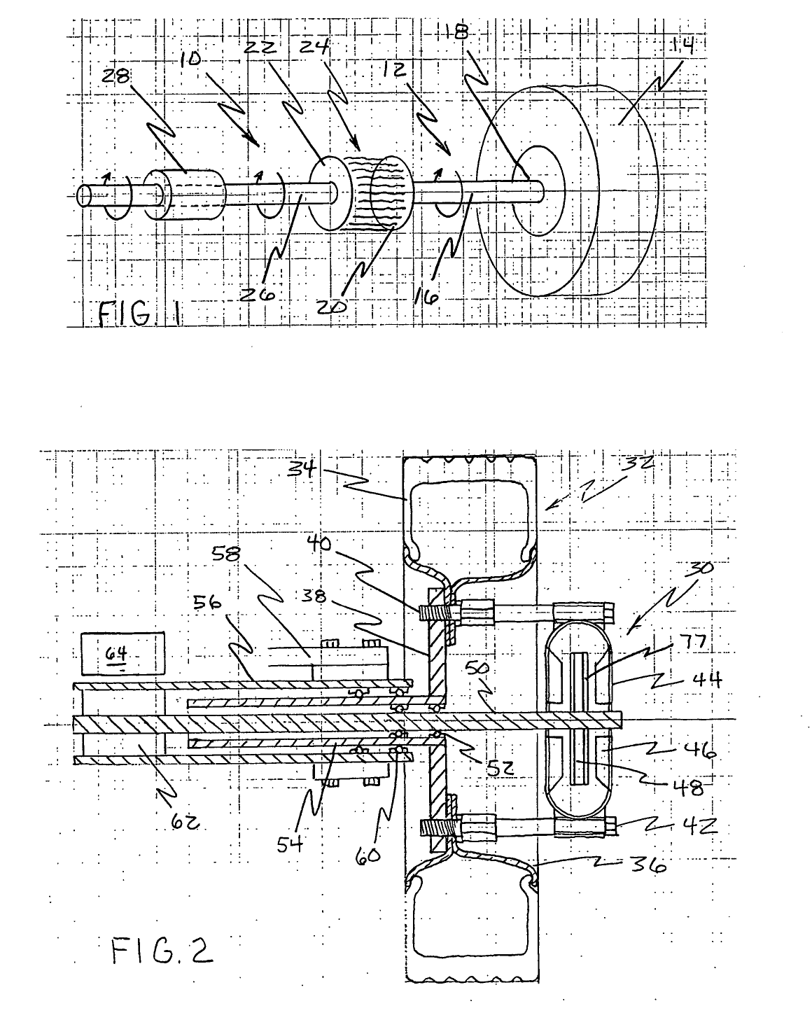

Reference is now made to FIG. 2 for a detailed description of the specific components of the present invention that together effect the above-described function. Speed retarding system 30 is positioned on the outside face of wheel/tire combination 32. In FIG. 2, tire 34 is shown in cross sectional configuration as it would be positioned on wheel rim 36. Wheel rim 36 is attached to the vehicle by way of attachment to axle shaft flange 38. Wheel lug nuts/bolts 40 are positioned through wheel rim 36 to rigidly attach it to axle shaft flange 38.

Speed retarder system 30 is attached to wheel 36 by way of impeller case wheel bolts 42. These bolts are positioned, in the preferred embodiment, immediately over wheel lug nuts/bolts 40 and attached thereto in a manner well known in the art. The placement of impellar case wheel bolts 42 and their attachment to wheel lug nuts/bolts 40 rigidly attach impeller case 44 to wheel/tire combination 32. Impeller case 44 therefore rotates in conjunction with wheel/tire combination 32.

Within impeller case 44 are positioned impeller case ribs 46 which are rigidly attached to the inside wall surfaces of impeller case 44, as well as impeller vanes 48 and impeller discs 77 which are free to rotate within impeller case 44 between impeller case ribs 46. This structure is described in more detail below.

Impeller vanes 48 and impeller discs 77 are rigidly positioned on restraining shaft 50 which passes through impeller case 44 and additionally through the center of rotating axle shaft 54. Restraining shaft bearings 52 position and allow the rotation of restraining shaft 50 within axle shaft 54.

Axle shaft 54 is positioned within axle housing 56 which itself is rigidly positioned on the vehicle by means of axle mount 58. The axle shaft and axle housing structures are typical of trailered vehicles and the like. Axle shaft bearings 16 stabilize the rotating axle shaft 54.

At the end of restraining shaft 50 is positioned locking mechanism 62 which is shown generically in FIG. 2 since it may be any of a number of known mechanisms for stopping the rotation of a rotating shaft. Lock activator 64 is positioned adjacent to locking mechanism 62 and responds to the activation of the foundation braking system of the vehicle as described above. It should be noted that the foundation braking system of the vehicle is not shown in FIG. 2 for clarity but would typically be positioned behind axle shaft flange 38 with either a braking disc or drum configuration.

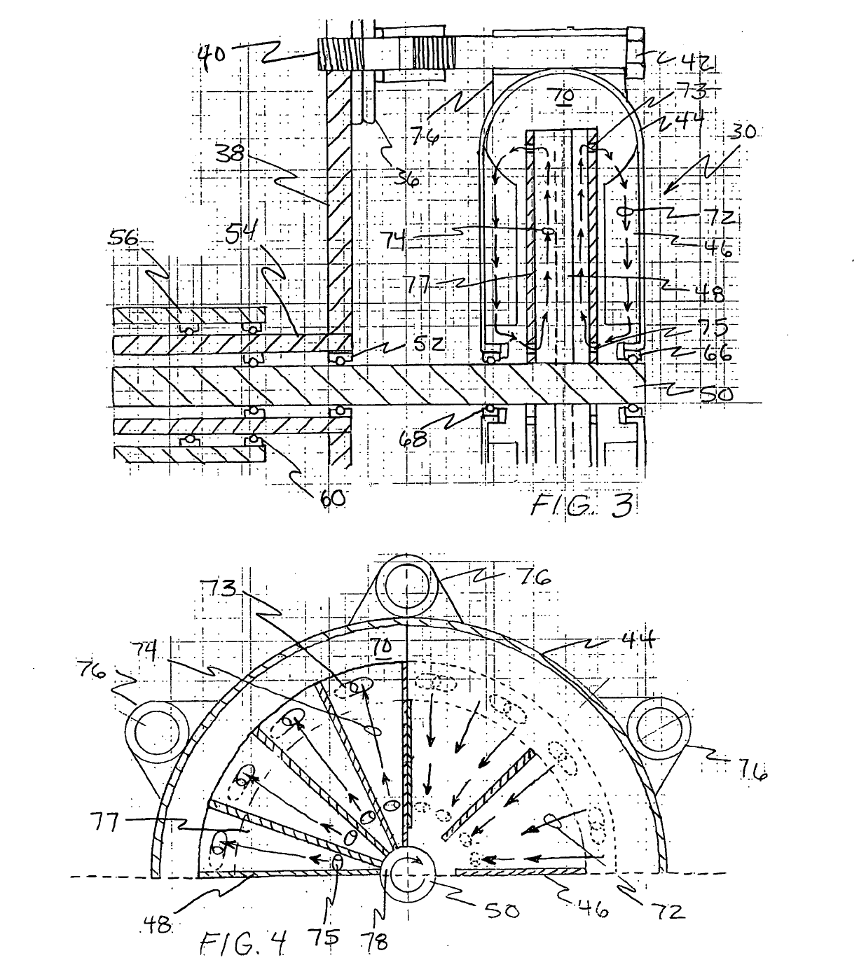

Reference is now made to FIG. 3 for a detailed description of the internal structures of the impeller case component of the present invention. Various wheel/tire components are not shown in FIG. 3 for clarity. Speed retarding system 30 is shown positioned on axle shaft flange 38 in the same manner as described above. Wheel 36 is attached to axle shaft flange 38 by means of wheel lug nuts/bolts 40. Impeller case 44 is attached to axle shaft flange by way of impeller case wheel bolts 42 which are attached to wheel lug nuts/bolts 40 in the preferred embodiment.

Impeller case 44 is a hollow disc-shaped enclosure, symmetrical about the axis formed by restraining shaft 50. Only an upper portion of impeller case 44 is shown in FIG. 3 as the balance of the component is symmetrically identical. Attached to the inside walls of impeller case 44 and positioned in a radial array described in more detail below, are impeller case ribs 46. Impeller case ribs 46 are positioned internally on both an outside inner face of impeller case 44 and an inside inner face. Between these two radial arrays of impeller case ribs 46 are positioned impeller vanes 48 and impeller discs 77 which are attached one to the other and are free to rotate with respect to impeller case 44 but for the viscous fluid 70 contained within impeller case 44. Outside impeller case bearing 66 and inside impeller case bearing 68 permit the rotation of impeller vanes 48 and impeller discs 77 with respect to impeller case ribs 46. These bearings 66 and 68 operate in conjunction with sealing devices as are well known in the art in order to contain viscous fluid 70 within impeller case 44.

The arrangement of impeller vanes 48 and impeller discs 77 with respect to impeller case ribs 46, and the rotation of restraining shaft 50 with the resultant rotation of impeller vanes 48 and impeller discs 77, forces the movement of viscous fluid 70 in a circulatory manner within impeller case 44. Impeller vanes 48 are bounded on either side by impeller discs 77. Impeller discs 77 are circular discs attached to restraining shaft 50 and to impeller vanes 48 to form what is essentially a fluid circulation chamber between the vanes and the discs. At least two arrays of apertures are positioned through impeller discs 77 to facilitate and direct a circulation of viscous fluid 70 therein. Apertures 73 are sized, shaped, and positioned to draw viscous fluid 70 through impeller discs 77 from between vanes 48 outward to ribs 46. Apertures 75 are sized, shaped, and positioned to draw viscous fluid 70 from between ribs 46 back into the “circulation chamber” described above. In this manner viscous fluid 70 is “pumped” through apertures 73 and 75 when shaft 50 is held stationary with respect to the rotating wheel. Fluid flow within the ribs is shown at 72 while fluid flow within the impeller vanes is shown at 74. The geometry of the impeller vanes, the impeller discs (and the apertures therein) and the impeller ribs, together with the fluid characteristics of viscous fluid 70, provide the necessary fluid shear between the two rotating systems to effect a counter rotational torque on the rotating wheel system.

The balance of the rotating mechanism disclosed in FIG. 3 includes restraining shaft 50 positioned within axle shaft 54 by means of restraining shaft bearings 52. Axle shaft 54 is itself positioned within axle housing 56 and may rotate with respect thereto by means of axle shaft bearing 60.

Reference is now made to FIG. 4 for a profile view of the primary components of speed retarding system 30. In FIG. 4, a two level partial cut away view of impeller case 44 is shown. In this view a plurality of mounting eyes 76 for receiving impeller case wheel bolts 42 are disclosed. These mounting eyes 76 are positioned in symmetrical arrangement as would be appropriate for a six lug wheel. Other mounting eye configurations based on other wheel configurations are of course anticipated.

The left hand side of FIG. 4 is cut away to show in profile the rotating impeller vanes 48 and impeller discs 77, while the right hand side of FIG. 4 is cut away to show the “fixed” impeller case ribs 46 with impeller discs shown in dashed lines. It is understood by reference to FIG. 3 how impeller vanes 48 and impeller discs 77 rotate within the confines defined by impeller case ribs 46 and thereby cause the flow of viscous fluid 70 through apertures 73 and 75 as shown. In FIG. 4 rotating restraining shaft 50 is shown with its radial array of impeller vanes 48. By reference again to FIG. 3 it is seen that impeller vanes 48 may be offset one from the next in alternating fashion so as to provide impeller vane eye 78 close to restraining shaft 50. In other words, the width of each impeller vane 48 does not completely bridge the gap between the opposing impeller discs 77 on either side. Impeller vanes 48 are alternatively offset one from the next so as to provide a channel by way of impeller vane eye 78 that receives the return flow of viscous fluid 70 as shown. This return flow is facilitated by the open plenum in the outward section of impeller case 44. The flow of viscous fluid 70 is shown at 72 and 74 in FIG. 4 in response to the rotation of restraining shaft 50, also as indicated in FIG. 4.

Once again, operation of the system of the present invention can be understood best by reference to FIGS. 1 and 2. Locking mechanism 28 (62 in FIG. 2) may be activated electrically, mechanically, or hydraulically in response to the activation of the foundation braking system of the vehicle. Alternately, if such concurrent activation is not desired, a separate means for activating locking mechanism 28 may be provided on the vehicle. In either case, activation of the locking mechanism serves to stop the rotation of the restraining shaft system of the present invention. An important characteristic of locking mechanism 28 is that it not degrade with temperature. The shock of the locking of shaft 26 should be readily absorbed by the viscous fluid in the system. Prior to such activation the restraining shaft system is rotating in conjunction with the rotation of the wheel axle system by means of the viscous fluid coupling described. As there is little or no resistive torque between the two systems prior to activation, the restraining shaft system rotates at approximately the same speed as the wheel axle system.

Once activated, however, the rotation of the restraining shaft is quickly brought to a stop. It is understood that the composition of the viscous fluid within the system should not be such as to create a sudden excessive counter rotational torque on the wheel axle system of the vehicle. A viscous fluid made of long chain polymer compounds with a viscosity rating ranging from 500,000 centipoise to 30,000,000 centipoises is appropriate for such operation. The arrangement shown for the internal structure of the impeller disc of the present invention provides a thrust balance along the axis of the restraining shaft which eliminates the need for large thrust bearings or wear plates. Impellers with vanes on one internal surface of the impeller disc component can provide equivalent retarding torque by using vanes of a greater depth than that shown in the preferred embodiment.

Once the restraining shaft is locked, the retarder system begins to act as a pump for the viscous fluid. The viscous fluid is pumped through the apertures in the impeller discs positioned near the impeller eye adjacent to the rotating axis of the restraining shaft and then radially outward towards the case plenum. In this process power is extracted from the system and converted to heat. The viscous fluid provides a smooth transition of speed between the restraining shaft system and the impeller case that is connected to the rotating wheel system. Additionally, the viscous fluid provides a mechanism for carrying heat from the friction surfaces (impeller and case walls) by pumping the fluid from the impeller center outward through the apertures at the perimeters of the impeller discs to the plenum where the heat may be dissipated. The viscous fluid returns through return ducts between the radial case ribs. These return ducts provide an additional large surface area from which heat may be extracted by convection and radiation. Convective heat transfer from the case to the external environment will occur as a result of the high velocity air flow that surrounds the rotating and translating wheels of the vehicle.

Once again, it is anticipated that operation of the system of the present invention reduces the load on the foundational brake components of the vehicle. In this manner, not only does the system of the present invention facilitate the braking process but generally assists in preventing the failure of the foundation brakes due to overheating as a result of excessive load.

Once again, it should be mentioned that the specific positioning of the components of the system of the present invention lend themselves to a retrofit installation on existing vehicle trailers and the like. Alternative placement of the components will be recognized by those skilled in the art when alternative vehicle structures are encountered. It is further anticipated that installation of the system of the present invention on original equipment might be better served by an internal positioning (between the wheels) of the system components. The only critical elements necessary to the proper positioning of the system components involve attachment of the impeller case to some part of the rotating wheel system of the vehicle/trailer and some access to an opposing end of the restraining shaft for the purposes of locking and stopping its rotation.

### Component Identification List

10. RESTRAINING SHAFT SYSTEM

12. WHEEL SHAFT SYSTEM

14. ROTATING WHEEL/TIRE

16. WHEEL SHAFT

18. RIGID WHEEL COUPLING

20. WHEEL SHAFT COUPLING FACE

22. RESTRAINING SHAFT COUPLING FACE

24. VISCOUS COUPLING FLUID

26. RESTRAINING SHAFT

28. LOCKING MECHANISM

30. SPEED RETARDING SYSTEM

32. WHEEL/TIRE COMBINATION

34. TIRE

36. WHEEL

38. AXLE SHAFT FLANGE

40. WHEEL LUG NUTS/BOLTS

42. IMPELLER CASE WHEEL BOLTS

44. IMPELLER CASE

46. IMPELLER CASE RIBS

48. IMPELLER VANES

50. RESTRAINING SHAFT

52. RESTRAINING SHAFT BEARINGS

54. AXLE SHAFT

56. AXLE HOUSING

58. AXLE MOUNT

60. AXLE SHAFT BEARINGS

62. LOCKING MECHANISM

64. LOCK ACTIVATOR

66. OUTSIDE IMPELLER CASE BEARING

68. INSIDE IMPELLER CASE BEARING

70. VISCOUS FLUID

72. FLUID FLOW WITHIN RIBS

73. CENTRAL APERTURES

74. FLUID FLOW WITHIN IMPELLER

75. PERIMETER APERTURES

76. MOUNTING EYES

77. IMPELLER DISCS

78. IMPELLER VANE EYE

1. A fluid coupled vehicle speed retarder for generating a controlled restraining torque on the wheel system of a moving vehicle that is in addition to the normal foundation braking system on the vehicle, the fluid coupled vehicle speed retarder comprising:
a restraining shaft assembly;
a quantity of a viscous fluid material;
a wheel and axle shaft assembly coupled by means of said viscous fluid material to said restraining shaft assembly and rigidly coupled to one or more of the rotating wheels of the vehicle; and
means for preventing the rotation of said restraining shaft assembly with respect to the vehicle and with respect to the wheel and axel shaft assembly;
wherein under normal operational conditions the restraining shaft assembly rotates in conjunction with the wheel and axle shaft assembly by means of the viscous fluid coupling but in the event of braking, the restraining shaft system is prevented from rotating with respect to the vehicle and with respect to the wheel and axle shaft system.

2. The speed retarder of claim 1 wherein said viscous fluid coupling is established within an impeller vane and disc enclosure, and serves to create a counter rotational force on the wheel and axle shaft assembly connected to the wheels of the vehicle.

3. The speed retarder of claim 2 wherein said impeller enclosure comprises a plenum through which a radial array of impeller vanes and impeller discs rotate adjacent to a radial array of impeller ribs that, by counter rotation, serve to force a circulation of the viscous fluid within the impeller enclosure, said impeller enclosure case connected to the wheel system of the vehicle and rotating at wheel speed, said impeller vane and impeller disc components of the system rigidly connected to the restraining shaft assembly and respond to the fixed or rotating condition of the restraining shaft.
